(19) United States
(12) Patent Application Publication
(10) Pub. No.: US 2017/0222908 A1
(43) Pub. Date: Aug. 3, 2017

(54) DETERMINING CANDIDATES FOR ROOT-CAUSE OF BOTTLENECKS IN A STORAGE NETWORK

(71) Applicant: HEWLETT PACKARD ENTERPRISE DEVELOPMENT LP, Houston, TX (US)

(72) Inventors: Vijay Ram Sevagapandian, Bangalore (IN); Vikram Krishnamurthy, Bangalore (IN); Thavamaniraja Sakthivel, Bangalore (IN)

(21) Appl. No.: 15/407,461

(22) Filed: Jan. 17, 2017

(30) Foreign Application Priority Data
Jan. 29, 2016 (IN) 201641003246

(51) Int. Cl. H04L 12/26; H04L 12/751; H04L 29/08

(52) U.S. Cl. CPC H04L 43/0888; H04L 67/1038; H04L 45/02

(57) ABSTRACT

In an example implementation, a network topology map with storage paths between servers and storage volumes of storage arrays in a storage network through network switches may be generated. A network switch may be identified from the network switches in the network topology map as a bottleneck by monitoring a performance parameter for each of the network switches. The performance parameter is indicative of I/O load at a port of a respective network switch. Storage volumes in the network topology map and connected to the bottlenecked network switch may be identified, and storage volume I/O metrics associated with each of the servers with respect to the identified storage volumes may be aggregated. Based on the aggregated storage volume I/O metrics, at least one of the servers may be determined as a candidate for a root-cause of the bottleneck.

### BACKGROUND

A storage network includes storage devices, in the form of storage arrays, which are accessible by servers through network switches. The network switches may include access gateways and fabric switches. The storage arrays include storage volumes that store data. The servers perform I/O operations on the storage volumes in the storage arrays for the purposes of reading and writing data. A bottleneck may occur at a port of a network switch in the storage network when the number of I/O operations across that network switch are large. The root-cause of the bottleneck may be servers performing the I/O operations through the bottlenecked network switch.

### BRIEF DESCRIPTION OF DRAWINGS

The following detailed description references the drawings, wherein:

FIG. 1 illustrates a computing system for root-cause analysis of bottlenecks in a storage network, according to an example implementation of the present subject matter;

FIG. 2(a) illustrates interconnections in a storage network identified by the computing system, according to an example implementation of the present subject matter;

FIG. 2(b) illustrates a network topology map generated by the computing system, according to an example implementation of the present subject matter;

FIG. 3 illustrates a method for root-cause analysis of bottlenecks in a storage network, according to an example implementation of the present subject matter;

FIG. 4 illustrates a method for load balancing for removal of bottlenecks in the storage network, according to an example implementation of the present subject matter; and

FIG. 5 illustrates a system environment for root-cause analysis of bottlenecks in a storage network, according to an example implementation of the present subject matter.

### DETAILED DESCRIPTION

In some examples, the present subject matter relates to root-cause analysis of bottlenecks in a storage network, such as a storage area network (SAN), connected to servers. The root-cause analysis may involve identification of servers that cause a bottleneck at a network switch in the storage network.

Network switches in a storage network may provide routes for storage paths for servers to access storage volumes of storage arrays. The storage network, for example a SAN, may have interface network switches that act as entry points for servers to connect to the storage network and access the storage volume of the storage arrays. The storage network, at the core, may have multi-layered fabric switches. For performing I/O operations from a server to a storage volume of a storage array, a host-bus adaptor (HBA) of the server connects to an interface network switch in the storage network. The interface network switch further connects through fabric switches to a storage array port associated with the storage volume of the storage array. The connection between the HBA, the interface network switch, the fabric switches, and the storage array port may form a storage path between the server and the storage volume of the storage array. Although I/O operations from each of the servers connected to the storage network may be performed over a unique storage path, each network switch in the storage network may be a part of multiple storage paths from different servers.

I/O operations from a server to a storage volume impart an I/O load on ports of the network switches in the associated storage path. In cases when the total I/O load on a port of a network switch saturates, i.e., exceeds the I/O load handling capacity of the port of the network switch, the network switch becomes a bottleneck. Candidates for a root-cause of the bottleneck may be servers causing the I/O load on the port to exceed the I/O load handling capacity. The bottleneck may get removed when such servers are removed from the storage paths that have the bottlenecked network switch.

For identification of the root-cause of the bottleneck, servers may be contacted to analyze their I/O operations and estimate the I/O load on the bottlenecked network switch. Since the servers may be behind a network address translation (NAT) firewall, contact and communication with the servers and identification of the root-cause in such an environment may, for example, be computationally complex and difficult. Also, isolating the root-cause may be difficult when multiple servers are connected to a single interface network switch in the storage network. Such computational complexities and difficulties may lead to a substantially high mean-time-to-resolution for bottlenecks which may affect the performance of the servers and the storage network. Further, separate systems may, for example, be utilized for identifying the bottleneck in the storage network and for analyzing the servers for identifying the root-cause because a single system may not to have the privilege to access the storage network as well as the servers by bypassing the NAT firewall.

The present subject matter describes example methods and systems for identification of a bottlenecked network switch in a storage network and a root-cause of the bottleneck. The methods and the systems of the present subject matter may facilitate identification of the bottlenecked network switch and the root-cause without any contact or communication with the servers connected to the storage network.

In accordance with an example implementation of the present subject matter, a network topology map of the storage network connected to servers is generated. The network topology map may include storage paths between the servers and storage volumes of storage arrays in the storage network through network switches. The network topology map may be generated without communicating with the servers.

The network switches in the network topology map may be monitored for their respective performance parameters. The performance parameter of a network switch may be indicative of I/O load at each port of the network switch. Based on the performance parameter, a bottlenecked network switch may be determined from the network switches in the network topology map. For example, when the performance parameter indicates that the I/O load at a port of a network switch has exceeded the I/O load handling capacity of the port, the network switch may be identified to be the bottleneck.

For the purposes of identification of a root-cause for the bottleneck at the network switch, storage volumes of the storage arrays in the network topology map that are connected to the bottlenecked network switch may be identified. Storage volume I/O metrics associated with each of the servers with respect to the identified storage volumes may be aggregated. Based on the aggregated storage volume I/O metrics, at least one of the servers may be determined as a candidate for the root-cause of the bottleneck. For example, the servers may be ranked according to the aggregated storage volume I/O metrics. The top ranked servers having the highest aggregated storage volume I/O metrics may be determined as candidates for the root-cause of the bottleneck.

With the methods and the systems of the present subject matter, the root-cause for the bottleneck at the network switch in the storage network may, for example, be identified without any contact or communication with the servers, which may, for example, help in reducing the computational complexities and difficulties associated with analysis of the servers for the root-cause identification. As a result, the mean-time-to-resolution of bottlenecks may, for example, reduced which improves the performance of the storage network and the servers due to faster resolution of the bottlenecks. Further, since the servers may, for example, not contacted or communicated with, the bottlenecks and the root-cause of the bottlenecks may be identified using a single computing system.

The following detailed description refers to the accompanying drawings. Wherever possible, the same reference numbers are used in the drawings and the following description to refer to the same or similar parts. While several examples are described in the description, modifications, adaptations, and other implementations are possible. Accordingly, the following detailed description does not limit the disclosed examples. Instead, the proper scope of the disclosed examples may be defined by the appended claims.

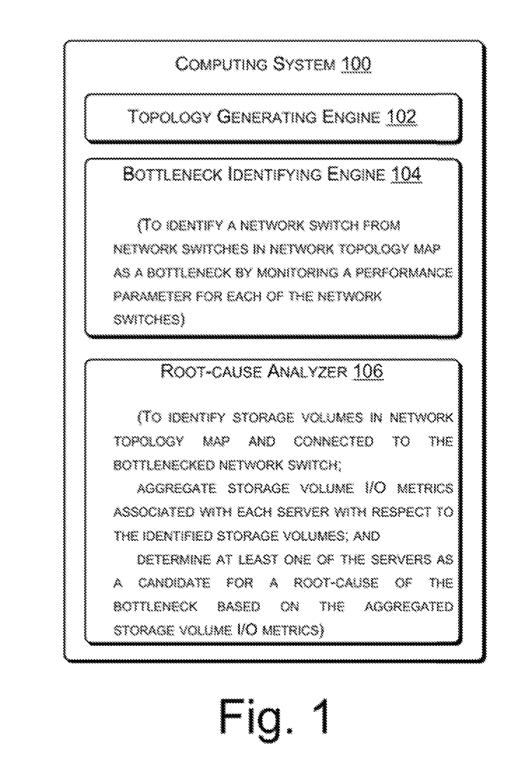

FIG. 1 illustrates a computing system 100 for root-cause analysis of bottlenecks in a storage network, according to an example implementation of the present subject matter. The computing system 100, hereinafter referred to as the system 100, may be implemented in various ways. For example, the system 100 may be a special purpose computer, a server, a mainframe computer, and/or any other type of computing device. The system 100 enables identification of a bottleneck with respect to I/O operations from servers connected to a storage network and also identification of a root-cause of the bottleneck, in accordance with the present subject matter.

As shown in FIG. 1, the system 100 includes a topology generating engine 102, a bottleneck identifying engine 104, and a root-cause analyzer 106. The topology generating engine 102, the bottleneck identifying engine 104, and the root-cause analyzer 106 may collectively be referred to as engine(s) which can be implemented through a combination of any suitable hardware and computer-readable instructions. The engine(s) may be implemented in a number of different ways to perform various functions for the purposes of identifying a bottleneck and a root-cause of the bottleneck in a storage network, for example a SAN. For example, the computer-readable instructions for the engine(s) may be processor-executable instructions stored in a non-transitory computer-readable storage medium, and the hardware for the engine(s) may include a processing resource (e.g., processor(s)), to execute such instructions. In the present examples, the non-transitory computer-readable storage medium stores instructions that, when executed by the processing resource, implements the engine(s). The system 100 may include the non-transitory computer-readable storage medium storing the instructions and the processing resource (not shown) to execute the instructions. In an example, the non-transitory computer-readable storage medium storing the instructions may reside outside the system 100, but accessible to the system 100 and the processing resource of the system 100. In another example, the engine(s) may be implemented by electronic circuitry.

The processing resource of the system 100 may be implemented as microprocessors, microcomputers, microcontrollers, digital signal processors, central processing units, state machines, logic circuitries, and/or any devices that manipulate signals based on operational instructions. Among other capabilities, the processing resource may fetch and execute computer-readable instructions stored in a non-transitory computer-readable storage medium coupled to the processing resource of the system 100. The non-transitory computer-readable storage medium may include, for example, volatile memory (e.g., RAM), and/or non-volatile memory (e.g., EPROM, flash memory, NVRAM, memristor, etc.).

A procedure for identifying a bottleneck and a root-cause of the bottleneck in a storage network using the system 100 in accordance with an example implementation is now described. Example implementations of the present subject matter are described with reference to a network environment in which servers are connected to a storage network through HBAs, and the storage network includes interface network switches (e.g., access gateways) and multi-layered fabric switches that provide network connectivity between the servers and storage arrays of the storage network. A similar procedure can however be implemented for other network environments having servers connected to other storage networks in a different manner. The other storage networks may include computing devices, communication devices, and network devices, in addition to storage arrays and network switches.

The topology generating engine 102 of the system 100 may generate a network topology map with storage paths between the servers and the storage arrays. The storage paths depict connectivity between the HBAs of the servers and storage volumes of the storage arrays through network switches in the storage network. The network switches may include interface network switches and fabric switches.

The topology generating engine 102 may discover the network switches and the storage arrays in the storage network, and identify interconnections between the network switches and the storage arrays to generate the network topology map. The topology generating engine 102 may communicate with each of the storage arrays, for example, through a polling mechanism, and request each storage array to provide its identity and information of storage volumes in a respective storage array. On receiving such a request, each storage array may provide its device identifier (ID) and IDs of the associated storage volumes. The topology generating engine 102 may also communicate with each of the network switches, for example, through a polling mechanism, and request each network switch to provide its identity and port connectivity details. On receiving such a request, each network switch may provide its device ID and the associated port connectivity details. The port connectivity details for a network switch may indicate connectivity of ports of the network switch with ports of other devices in the network environment. For example, the port connectivity details for a fabric switch may indicate which port of the fabric switch is connected to which port of an interface network switch or of another fabric switch, or a storage array. The port connectivity details for a interface network switch may indicate which port of the interface network switch is connected to which port of a fabric switch. The topology generating engine 102 may identify interconnections between the network switches and the storage volumes of the storage arrays based on the device IDs and the port connectivity details. The topology generating engine 102 may communicate either directly or indirectly with the network switches and the storage arrays. The topology generating engine 102 may communicate indirectly through a network.

The port connectivity details for an interface network switch may also indicate which port of the interface network switch is connected to which HBA. Based on such details, the topology generating engine 102 may identify interconnections between the interface network switches and the HBAs. It may be noted that the topology generating engine 102 does not communicate with the servers connected to the storage network. Thus, the servers to which the HBAs belong cannot be determined and the storage paths from the servers to the storage volumes cannot be identified based on the port connectivity details.

For identifying the storage paths from the servers to generate the network topology map, the topology generating engine 102 may obtain storage presentation details stored in the storage arrays. The storage presentation details includes information of HBAs to which different storage volumes of the storage array are exposed, and servers to which the different storage volumes are exposed. Based on the storage presentation details, the topology generating engine 102 may identify the HBAs belonging to each of the servers and identify the storage paths from the servers to generate the network topology map.

To illustrate generation of the network topology map using the system 100, consider a case where a storage network includes two storage arrays SA1 and SA2. Each of the two storage arrays SA1 and SA2 have a set of four storage volumes (A, B, C, D) and (E, F, G, H), respectively. The storage network has two interface network switches AG1 and AG2 (e.g., access gateways). The interface network switches AG1 and AG2 are connected to the storage volumes of the storage arrays SA1 and SA2 through four fabric switches FS1 to FS4 and through storage array ports S1 to S8. Further, four servers S1 to S4 are connected to the storage network through eight HBAs H1 to H8 for accessing the storage volumes of the storage arrays SA1 and SA2.

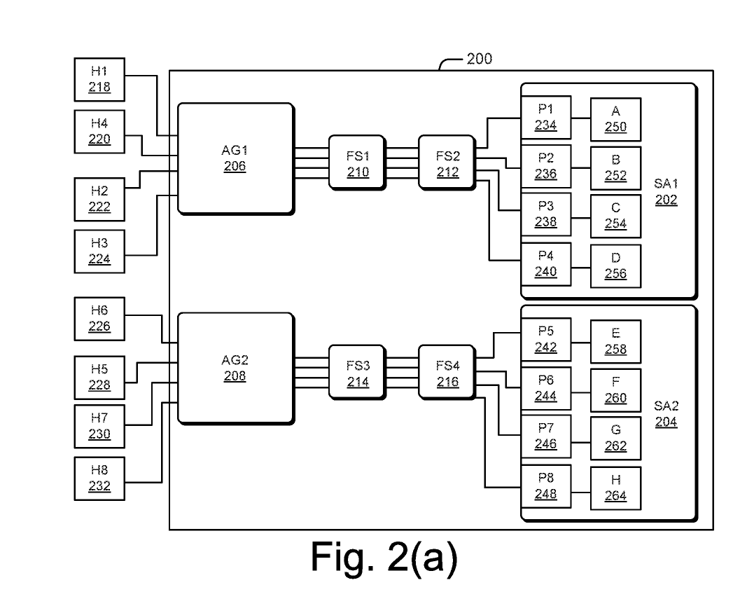

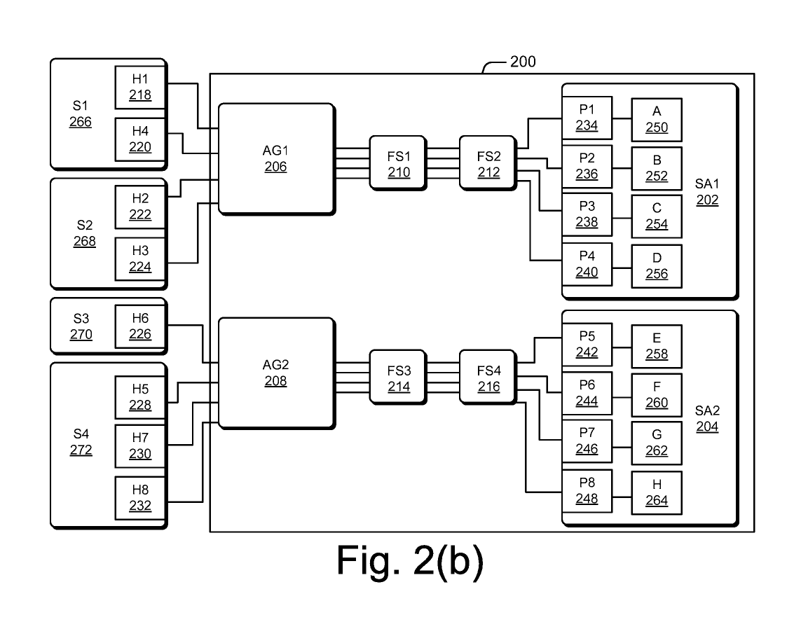

With reference to the above illustrated example, the topology generating engine 102 may discover the interface network switches, the fabric switches, and the storage arrays, and identify interconnections therebetween. The topology generating engine 102 may also identify interconnections between the interface network switches and the HBAs. FIG. 2(a) illustrates interconnections in the storage network 200 identified by the computing system 100, according to an example implementation of the present subject matter. The storage arrays are referenced by 202 and 204. The interface network switches are referenced by 206 and 208. The fabric switches are referenced by 210, 212, 214, and 216. The HBAs are referenced by 218, 220, 222, . . . , 232. The storage array ports are referenced by 234, 236, 238, . . . , 248. The storage volumes are referenced by 250, 252, 254, . . . , 264.

For generating the network topology map, the topology generating engine 102 may obtain storage presentation details from the storage arrays. Table 1 illustrates example information included in the storage presentation details. As illustrated, the storage presentation details provides information of the HBAs exposed to the storage volumes and the storage arrays ports P1 to P8 through which the servers (not shown in FIG. 2(a)) are exposed to storage volumes.

TABLE 1

| | | | Storage | |
|---|---|---|---|---|
| Storage | Storage | | Arrays | |
| Arrays | Volume | HBAs | Ports | Server |
| SA1 | A | H1 | P1 | 1 |
| | B | H2 | P2 | 2 |
| | C | H3 | P3 | 2 |
| | D | H4 | P4 | 1 |
| SA2 | E | H5 | P5 | 4 |
| | F | H6 | P6 | 3 |
| | G | H7 | P7 | 4 |
| | H | H8 | P8 | 4 |

The topology generating engine 102 may analyze the storage presentation details to logically group the HBA(s) belonging to each of the servers. For example, HBAs H1 and H4 belong to server S1, HBAs H2 and H3 belong to server S2, HBA H6 belongs to server S3, and HBAs H5, H7 and H8 belong to server S4. Based on the logical grouping, the topology generating engine 102 may identify the storage paths from the servers to the storage volumes of the storage arrays to generate the network topology map. FIG. 2(b) illustrates a network topology map generated by the computing system 100, according to an example implementation of the present subject matter. The servers are referenced by 266, 268, 270, and 272.

In an example implementation, the topology generating engine 102 may communicate with the network switches and the storage arrays in the storage network at a predefined time interval to update the network topology map. The updated network topology map may be utilized to identify bottlenecks and the root-cause in real-time.

For identifying a bottleneck, the bottleneck identifying engine 104 may monitor each of the network switches existing in the network topology map. The bottleneck identifying engine 104 may monitor a performance parameter for each of the network switches, where the performance parameter indicates I/O load at each port of a respective network switch. The bottleneck identifying engine 104 may monitor the performance parameter for each network switch at a predefined time interval, and identify a network switch in the network topology map as a bottleneck, when the performance parameter indicates that the I/O load at a port of that network switch has exceeded its I/O load handling capacity.

In an example implementation, the performance parameter is buffer-to-buffer credits (BBCs) for each port of the network switch. The BBCs for a port, at a time instance, indicates how much more I/O load the port can handle at that time instance. In other words, how many more I/O operations servers can perform on storage volumes through that port. The BBCs for a port reduce with increase in the I/O load at the port. A zero BBC for a port indicates saturation of I/O load at the port. Thus, when the BBCs of a port of a network switch is zero for a predefined time period, the network switch is identified to be the bottleneck.

After identifying the bottlenecked network switch, the root-cause analyzer 106 may identify storage volumes that are existing in the network topology map and connected to the bottlenecked network switch. The root-cause analyzer 106 may obtain storage volume I/O metrics for each of the identified storage volumes. The storage volume I/O metrics for a storage volume indicates the number of I/O operations performed by the server connected to the storage volume.

After obtaining the storage volume I/O metrics for the identified storage volumes, the root-cause analyzer 106 may aggregate the storage volume I/O metrics associated with each of the servers with respect to the identified storage volumes. The aggregated storage volume I/O metrics for a server indicates the number of I/O operations performed by that server on the identified storage volumes through the bottlenecked network switch.

To illustrate with an example, for the network topology map shown in FIG. 2(b), consider a case where fabric switch FS3 is identified as the bottlenecked network switch. The root-cause analyzer 106 may thus identify storage volumes E, F, G and H in the network topology map that are connected to fabric switch FS3. The root-cause analyzer 106 may then obtain the storage volume I/O metrics for storage volumes E to H, and aggregate the storage volume I/O metrics associated with each of servers S3 and S4. Examples of the storage volume I/O metrics for storage volumes E to H and the aggregated storage volume I/O metrics associated with each of servers S3 and S4 are illustrated in Table 2.

TABLE 2

| | | Aggregate |
|---|---|---|
| | Storage | storage |
| Storage | volume | volume |
| Volume | I/O metrics | I/O metrics |
| E | S3 = 100 | S3 = 100 |
| | S4 = 0 | S4 = 250 |
| F | S3 = 0 | |
| | S4 = 50 | |
| G | S3 = 0 | |
| | S4 = 100 | |
| H | S3 = 0 | |
| | S4 = 100 | |

Based on the aggregated storage volume I/O metrics, the root-cause analyzer 106 may determine at least one server as a candidate for a root-cause of the bottleneck. In an example implementation, the root-cause analyzer 106 may rank the servers according to their aggregated storage volume I/O metrics. For example, servers for which the aggregated storage volume I/O metrics are higher may be ranked higher. In another example implementation, the servers may be ranked based on a percentile analysis. The root-cause analyzer 106 may then determine at least one of the top ranked servers having the highest aggregated storage volume I/O metrics as a candidate for the root-cause. In an example implementation, a predefined number of top ranked servers (e.g. top 3 servers) may be determined as candidates for the root-cause. With reference to the example illustrated in Table 2, server S4 may be a candidate for the root-cause of the bottleneck at fabric switch FS3.

In an example implementation, the system 100 may perform a load balancing analysis for removing the bottleneck in the storage network. In the load balancing analysis, the system 100 may identify at least one top ranked server which when removed from the interface network switch in the associated storage path alleviates the bottleneck. The system 100 may also identify another interface network switch which can accommodate the identified top ranked server(s) and handle additional I/O operations without creating another bottleneck.

In an example implementation, the system 100 may include a load balancing engine (not shown) to perform various functions for the load balancing analysis for removing a bottleneck in the storage network. The load balancing engine may be implemented through a combination of any suitable hardware and computer-readable instructions, in a similar manner as the topology generating engine 102, the bottleneck identifying engine 104, and the root-cause analyzer 106.

When the bottlenecked network switch is not at an interface of the storage network, the load balancing engine may identify the interface network switch existing in the network topology map and connected to the bottlenecked network switch. The load balancing engine may then exclude the top ranked server having the top aggregated storage volume I/O metrics and determine an I/O load on the identified interface network switch by aggregating the storage volume I/O metrics associated with the remaining servers connected to the identified interface network switch. The load balancing engine may compare the determined I/O load with historical I/O load values at the identified interface network switch to determine whether exclusion of the top ranked server is able to remove the bottleneck. The historical I/O load values indicate I/O loads that the interface network switch handled previously without creating a bottleneck in the storage paths through the interface network switch. If the load balancing engine determines that the bottleneck is not removed by excluding the top ranked server, then the load balancing engine may repeat the above described procedure by excluding top two ranked servers. The load balancing engine may iteratively repeat the procedure until at least one server is identified which when excluded from the interface network switch removes the bottleneck.

Further, the load balancing engine may determine an I/O load on another interface network switch in the network topology map by aggregating the storage volume I/O metrics associated with the servers connected to the other interface network switch and associated with the at least one excluded server. The load balancing engine may then compare this I/O load with historical I/O load values at this other interface network switch to determine whether the at least one excluded server can be accommodated at the other interface network switch without creating a bottleneck. The load balancing engine may repeatedly perform the above described procedure until a new interface network switch is identified to which the at least one excluded server can be moved.

With the load balancing analysis, as described above, servers, which are a root-cause of a bottleneck, can be moved within the storage network for removal of bottleneck and also use un-utilized network switches in the storage network. This helps in utilizing the storage network efficiently.

Further, in an example implementation, the system 100 may include an information reporting engine (not shown) to generate a report including at least one of: information of the bottlenecked network switch; information of server(s) determined as a candidate for the root-cause of the bottleneck; information of the at least one excluded server which when moved out removes the bottleneck; and information of the other interface network switch which can accommodate the at least one excluded server. The information reporting engine may be implemented through a combination of any suitable hardware and computer-readable instructions, in a similar manner as the topology generating engine 102, the bottleneck identifying engine 104, and the root-cause analyzer 106.

In an example implementation, the report generated by the information reporting engine may be provided to a user of the system 100 who can perform activities to move the at least one excluded server to the other interface network switches for efficient utilization of the storage network.

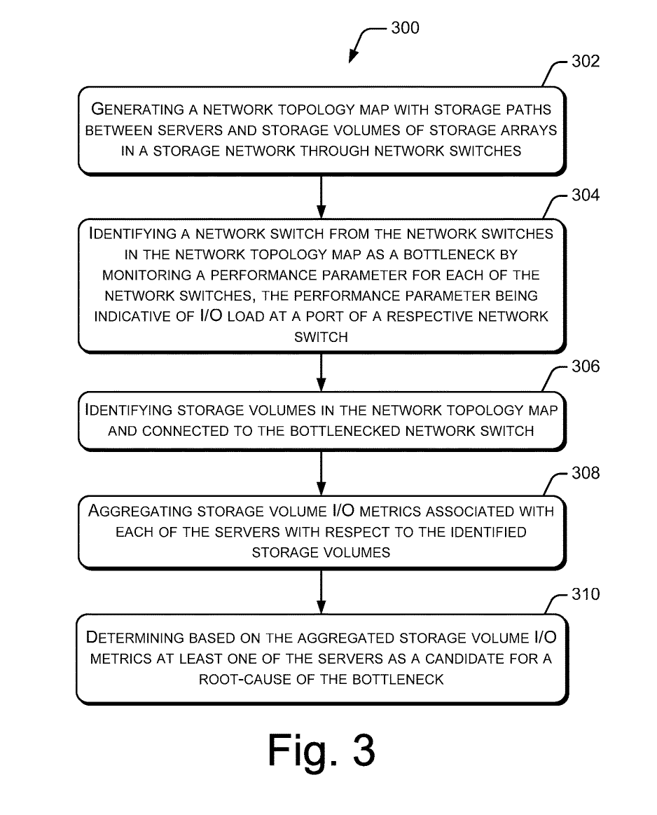

FIG. 3 illustrates a method 300 for root-cause analysis of bottlenecks in a storage network, according to an example implementation of the present subject matter. The method 300 can be implemented by processor(s) or computing system(s) through any suitable hardware, a non-transitory machine readable medium, or combination thereof. Further, although the method 300 is described in context of the aforementioned computing system 100, other suitable computing devices or systems may be used for execution of the method 300. It may be understood that processes involved in the method 300 can be executed based on instructions stored in a non-transitory computer-readable medium, as will be readily understood. The non-transitory computer-readable medium may include, for example, digital memories, magnetic storage media, such as a magnetic disks and magnetic tapes, hard drives, or optically readable digital data storage media.

Referring to FIG. 3, at block 302, a network topology map with storage paths between servers and storage volumes of storage arrays in a storage network through network switches may be generated. The network topology map is generated without any contact or communication with the servers connected to the storage network. The network topology map may be generated by the computing system 100 in a manner as described earlier. For generating the network topology map, the network switches and the storage arrays in the storage network may be discovered, interconnection between the network switches and the storage volumes of the storage arrays may be identified, and storage paths between the servers and the storage volumes may be determined based on the interconnections and information of the servers and the HBAs obtained from the storage presentation details in the storage arrays.

At block 304, a network switch from the network switches in the network topology map may be identified as a bottleneck, by monitoring a performance parameter for each of the network switches. The performance parameter is indicative of I/O load at a port of a respective network switch. In an example implementation, the performance parameter is BBCs of each port of each of the network switches. A network switch may be determined as a bottleneck by the computing system 100 when the BBCs for a port of the network switch are zero for a predefined time period.

At block 306, storage volumes in the network topology map and connected to the bottlenecked network switch may be identified. The network topology map may be traversed by the computing system 100 to identify the storage volumes connected to the bottlenecked network switch.

At block 308, storage volume I/O metrics associated with each of the servers with respect to the identified storage volumes may be aggregated. For this, as described earlier, the storage volume I/O metrics may be obtained from the identified storage volumes by the computing system 100, and the storage volume I/O metrics associated with each server may be aggregated.

At block 310, based on the aggregated storage volume I/O metrics, at least one of the servers may be determined as a candidate for a root-cause of the bottleneck. As described earlier, the servers may be ranked by the computing system 100 based on the associated aggregate storage volume I/O metrics. At least one of the top ranked servers may be determined as candidates for the root-cause.

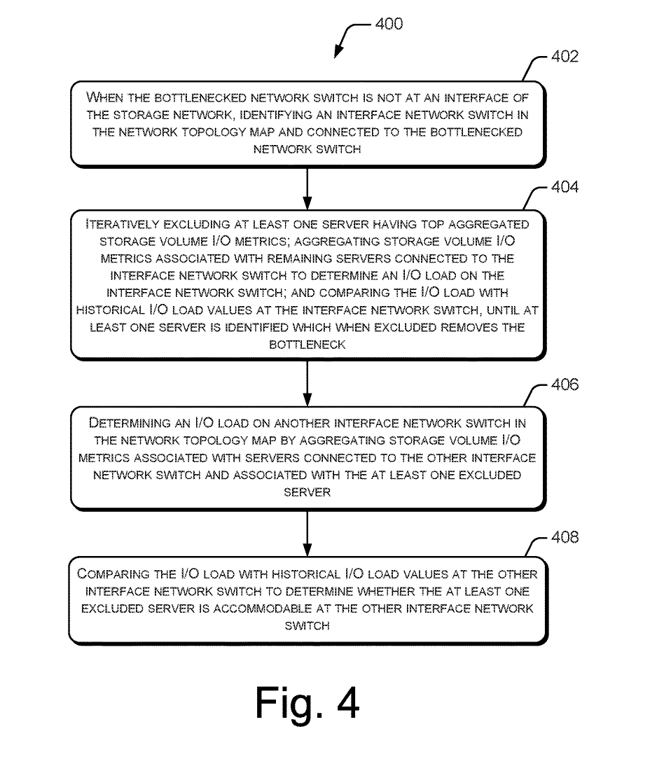

FIG. 4 illustrates a method 400 for load balancing for removal of bottlenecks in the storage network, according to an example implementation of the present subject matter. The method 400 can be implemented by processor(s) or computing system(s) through any suitable hardware, a non-transitory machine readable medium, or combination thereof. Further, although the method 400 is described in context of the aforementioned computing system 100, other suitable computing devices or systems may be used for execution of the method 400. It may be understood that processes involved in the method 400 can be executed based on instructions stored in a non-transitory computer-readable medium, as will be readily understood. The non-transitory computer-readable medium may include, for example, digital memories, magnetic storage media, such as a magnetic disks and magnetic tapes, hard drives, or optically readable digital data storage media.

At block 402, when the bottlenecked network switch is not at an interface of the storage network, an interface network switch in the network topology map and connected to the bottlenecked network switch may be identified. At block 404, iteratively, servers having top aggregated storage volume I/O metrics may be excluded; storage volume I/O metrics associated with remaining servers connected to the interface network switch may be aggregated to determine an I/O load on the interface network switch; and the I/O load may be compared with historical I/O load values at the interface network switch, until at least one server is identified which when excluded removes the bottleneck.

Further, at block 406, an I/O load on another interface network switch in the network topology map may be determined by aggregating storage volume I/O metrics associated with the servers connected to the other interface network switch and associated with the at least one excluded server. The I/O load may be determined by the computing system 100. At block 408, the I/O load may be compared with historical I/O load values at the other interface network switch to determine whether the at least one excluded server is accommodable at the other interface network switch. The comparison may be performed by the computing system 100.

In an example implementation, a report may be generated by the computing system 100, where the report includes at least one of: information of the bottlenecked network switch; information of server(s) determined as a candidate for the root-cause of the bottleneck; information of the at least one excluded server which when moved out removes the bottleneck; and information of the other interface network switch which can accommodate the at least one excluded server. The report may be provided to a user of the computing system 100 for performing activities to balance load in the storage network.

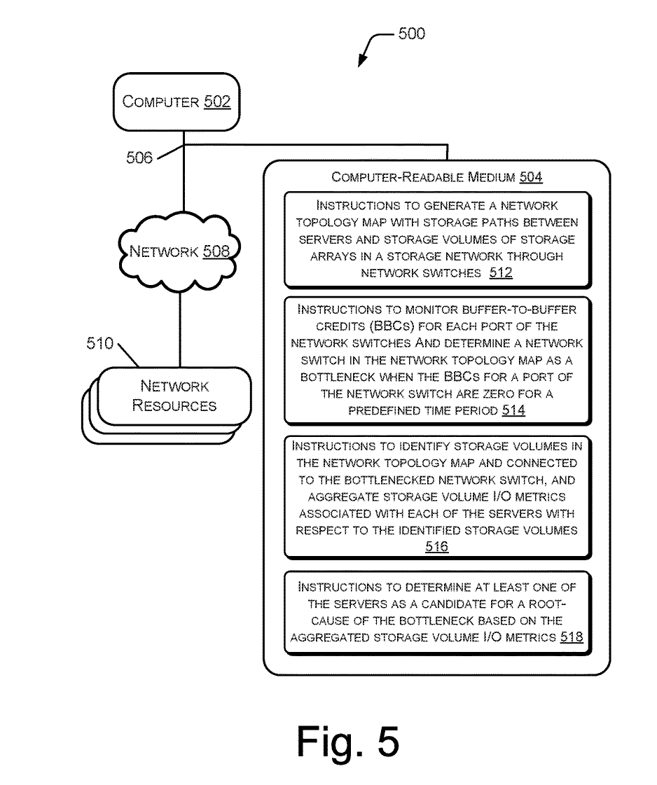

FIG. 5 illustrates a system environment 500 for root-cause analysis of bottlenecks in a storage network, according to an example implementation of the present subject matter. In an example implementation, the system environment 500 includes a computer 502 communicatively coupled to a non-transitory computer-readable medium 504 through a communication link 506. In an example, the computer 502 may be the computing system 100 having at least one processing resource for fetching and executing computer-readable instructions from the non-transitory computer-readable medium 504.

The non-transitory computer-readable medium 504 can be, for example, an internal memory device or an external memory device. In an example implementation, the communication link 506 may be a direct communication link, such as any memory read/write interface. In another example implementation, the communication link 506 may be an indirect communication link, such as a network interface. In such a case, the computer 502 can access the non-transitory computer-readable medium 504 through a network 508. The network 508 may be a single network or a combination of multiple networks and may use a variety of different communication protocols.

The computer 502 and the non-transitory computer-readable medium 504 may also be communicatively coupled to network resources 510 of a storage network over the network 508. The network resources 510 may include network switches and storage arrays of the storage network.

In an example implementation, the non-transitory computer-readable medium 504 includes a set of computer-readable instructions for root-cause analysis of bottlenecks in a storage network. The set of computer-readable instructions can be accessed by the computer 502 through the communication link 506 and subsequently executed to perform acts for the root-cause analysis.

Referring to FIG. 5, in an example, the non-transitory computer-readable medium 504 may include instructions 512 that cause the computer 502 to generate a network topology map with storage paths between servers and storage volumes of storage arrays in a storage network through network switches. For generating the network topology map, the non-transitory computer-readable medium 504 may include instructions that cause the computer 502 to discover the network switches and the storage arrays in the storage network, identify interconnections between the network switches and the storage volumes of the storage arrays, and determine the storage paths between the servers and the storage volumes based on the interconnections and based on information of the servers and host-bus adaptors (HBAs) to which the storage volumes are exposed, where the information is obtained from storage presentation details in the storage arrays.

The non-transitory computer-readable medium 504 may include instructions 514 that cause the computer 502 to monitor BBCs for each port of the network switches, and determine a network switch in the network topology map as a bottleneck when the BBCs for a port of the network switch are zero for a predefined time period.

The non-transitory computer-readable medium 504 may also include instructions 516 that cause the computer 502 to identify storage volumes in the network topology map and connected to the bottlenecked network switch, and aggregate the storage volume I/O metrics associated with each of the servers with respect to the identified storage volumes. The non-transitory computer-readable medium 504 may further include instructions 518 that cause the computer 502 to determine at least one of the servers as a candidate for a root-cause of the bottleneck based on the aggregated storage volume I/O metrics.

In an example implementation, the non-transitory computer-readable medium 504 may include instructions that cause the computer 502 to identify an access gateway in the network topology map and connect to the bottlenecked network switch, when the bottlenecked network switch is a fabric switch of the storage network. The non-transitory computer-readable medium 504 may also include instructions that cause the computer 502 to iteratively exclude at least one server having top aggregated storage volume I/O metrics; determine an I/O load on the access gateway by aggregating storage volume I/O metrics associated with remaining servers connected to the access gateway; and compare the I/O load with historical I/O load values at the access gateway, until at least one server is identified which when excluded removes the bottleneck. The at least one server may thus be the root-cause of the bottleneck.

In an example implementation, the non-transitory computer-readable medium 504 may further include instructions that cause the computer 502 to determine an I/O load on another interface network switch in the network topology map by aggregating the storage volume I/O metrics associated with the servers connected to the other interface network switch and associated with the at least one excluded server, and compare the I/O load with historical I/O load values at the other interface network switch to determine whether the at least one excluded server is accommodable at the other interface network switch.

In an example implementation, the non-transitory computer-readable medium 504 may further include instructions that cause the computer 502 to generate a report comprising at least one of: information of the bottlenecked network switch; information of at least one server determined as a candidate for the root-cause; information of at least one excluded server; and information of the other interface network switch.

Although implementations for root-cause analysis of bottlenecks in a storage network have been described in language specific to structural features and/or methods, it is to be understood that the present subject matter is not limited to the specific features or methods described. Rather, the specific features and methods are disclosed and explained as example implementations for root-cause analysis of bottlenecks in a storage network.

I/We claim:

1. A method comprising:
generating, by a computing system, a network topology map with storage paths between servers and storage volumes of storage arrays in a storage network through network switches;
identifying, by the computing system, a network switch from the network switches in the network topology map as a bottleneck by monitoring a performance parameter for each of the network switches, the performance parameter being indicative of I/O load at a port of a so respective network switch;
identifying, by the computing system, storage volumes in the network topology map and connected to the bottlenecked network switch;
aggregating, by the computing system, storage volume I/O metrics associated with each of the servers with respect to the identified storage volumes; and
determining based on the aggregated storage volume I/O metrics, by the computing system, at least one of the servers as a candidate for a root-cause of the bottleneck.

2. The method as claimed in claim 1, wherein the generating the network topology map comprises:
discovering the network switches and the storage arrays in the storage network;
identifying interconnections between the network switches and the storage volumes of the storage arrays; and
determining the storage paths between the servers and the storage volumes based on the interconnections and based on information of the servers and host-bus adaptors (HBAs) to which the storage volumes are exposed, wherein the information is obtained from storage presentation details in the storage arrays.

3. The method as claimed in claim 2, wherein the determining the storage paths comprises identifying HBAs belonging to each of the servers.

4. The method as claimed in claim 1, wherein the performance parameter comprises buffer-to-buffer credits (BBCs) for each port of the respective network switch, and wherein the network switch is identified as the bottleneck when the BBCs for a port of the network switch are zero for a predefined time period.

5. The method as claimed in claim 1, further comprising:
when the bottlenecked network switch is not at an interface of the storage network, identifying, by the computing system, an interface network switch in the network topology map and connected to the bottlenecked network switch;
iteratively excluding at least one server having top aggregated storage volume I/O metrics;
aggregating storage volume I/O metrics associated with remaining servers connected to the interface network switch to determine an I/O load on the interface network switch; and
comparing the I/O load with historical I/O load values at the interface network switch, until at least one server is identified which when excluded removes the bottleneck.

6. The method as claimed in claim 5, further comprising:
determining an I/O load on another interface network switch in the network topology map by aggregating storage volume I/O metrics associated with servers connected to the other interface network switch and associated with the at least one excluded server; and
comparing the I/O load with historical I/O load values at the other interface network switch to determine whether the at least one excluded server is accommodable at the other interface network switch.

7. A computing system comprising:
a topology generating engine to:
discover network switches and storage arrays of a storage network connected to servers; and
determine storage paths between the servers and storage volumes of the storage arrays through the network switches to so generate a network topology map, wherein the storage paths are determined based on interconnections between the network switches and the storage volumes, and by identifying, from storage presentation details in the storage arrays, host-bus adaptors (HBAs) belonging to each of the servers;
a bottleneck identifying engine to:
identify a bottlenecked network switch from the network switches in the network topology map by monitoring a performance parameter for each of the network switches, the performance parameter being indicative of I/O load at a port of a respective network switch; and
a root-cause analyzer to:
identify storage volumes in the network topology map and connected to the bottlenecked network switch;
aggregate storage volume I/O metrics associated with each of the servers with respect to the identified storage volumes; and
determine based on the aggregated storage volume I/O metrics at least one of the servers as a candidate for a root-cause of the bottleneck.

8. The computing system as claimed in claim 7, wherein the performance parameter comprises buffer-to-buffer credits (BBCs) for each port of the respective network switch, and wherein the network switch is identified as the bottleneck when the BBCs for a port of the network switch are zero for a predefined time period.

9. The computing system as claimed in claim 7, wherein the network switches comprises access gateways and fabric switches.

10. The computing system as claimed in claim 7, further comprising a load balancing engine to:
identify an interface network switch in the network topology map and connected to the bottlenecked network switch, when the bottlenecked network switch is not at an interface of the storage network;
iteratively exclude at least one server having top aggregated storage volume I/O metrics;
determine an I/O load on the interface network switch by aggregating storage volume I/O metrics associated with remaining servers connected to the interface network switch; and
compare the I/O load with historical I/O load values at the interface network switch, until at least one server is identified which when excluded removes the bottleneck, wherein the at least one server is the root-cause of the bottleneck.

11. The computing system as claimed in claim 10, wherein the load balancing engine is to:
determine an I/O load on another interface network switch in the network topology map by aggregating storage volume I/O metrics associated with servers connected to the other interface network switch and associated with the at least one excluded server; and
compare the I/O load with historical I/O load values at the other interface network switch to determine whether the at least one excluded server is accommodable at the other interface network switch.

12. The computing system as claimed in claim 11, further comprising an information reporting engine to generate a report comprising at least one of:
information of the bottlenecked network switch;
information of the at least one of the servers determined as a candidate for the root-cause;
information of the at least one excluded server; and
information of the other interface network switch.

13. A non-transitory computer-readable medium comprising computer-readable instructions, which, when executed by a computer, cause the computer to:
generate a network topology map with storage paths between servers and storage volumes of storage arrays in a storage network through network switches;
monitor buffer-to-buffer credits (BBCs) for each port of the network switches;
determine a network switch in the network topology map as a bottleneck when the BBCs for a port of the network switch are zero for a predefined time period;
identify storage volumes in the network topology map and connected to the bottlenecked network switch;
aggregate storage volume I/O metrics associated with each of the servers with respect to the identified storage volumes; and
determine at least one of the servers as a candidate for a root-cause of the bottleneck based on the aggregated storage volume I/O metrics.

14. The non-transitory computer-readable medium as claimed in claim 13, wherein the instructions which, when executed by the computer, cause the computer to:
discover the network switches and the storage arrays in the storage network;
identify interconnections between the network switches and the storage volumes of the storage arrays; and
determine the storage paths between the servers and the storage volumes based on the interconnections and based on information of the servers and host-bus adaptors (HBAs) to which the storage volumes are exposed, wherein the information is obtained from storage presentation details in the storage arrays.

15. The non-transitory computer-readable medium as claimed in claim 13, wherein the instructions which, when executed by the computer, cause the computer to:
identify an access gateway in the network topology map and connected to the bottlenecked network switch, when the bottlenecked network switch is a fabric switch of the storage network;
iteratively exclude at least one server having top aggregated storage volume I/O metrics;
determine an I/O load on the access gateway by aggregating storage volume I/O metrics associated with remaining servers connected to the access gateway; and
compare the I/O load with historical I/O load values at the access gateway, until at least one server is identified which when excluded removes the bottleneck, wherein the at least one server is the root-cause of the bottleneck.
